(19) United States
(12) Patent Application Publication
(10) Pub. No.: US 2005/0174279 A1
(43) Pub. Date: Aug. 11, 2005

(54) Device and method for the single sideband modulation of a radar device

(76) Inventor: Klaus Voigtlaender, Wangen (DE)

Correspondence Address: Striker Striker & Stenby, 103 East Neck Road, Huntington, NY, 11743, US

(21) Appl. No.: 10/516,042

(22) PCT Filed: Jun. 13, 2003
(86) PCT No.: PCT/DE03/01980

(30) Foreign Application Priority Data
Sep. 3, 2002 (DE) 102 40 497.6

(51) Int. Cl. G01S 13/93

(52) U.S. Cl. 342/70; 342/109; 342/194

(57) ABSTRACT

The present invention relates to a radar measuring device capable of being used for a motor vehicle in particular, and to a method for operating a radar measuring device.

To occupy a narrow bandwidth, a radar measuring device includes a high-frequency oscillator (14) for producing a carrier frequency signal (w24), transmission means (11, 16, 18) for producing and emitting a radar pulse signal, whereby the transmission means include a first pulse-shaping device (11) for producing a first pulse signal (w1) and a transmission antenna (18) for emitting a first radar pulse signal (R1) composed of the first pulse signal (w1) and the carrier frequency signal (w24), reception means (19, 21) for receiving a radar signal (R2), and processing means (12, 21, 22, 23, 25, 26, 29, 30) for processing the received radar signal (R2), whereby the processing means include a second pulse-shaping device (25) for producing a second pulse signal (w2), whereby the transmission means include a single-sideband mixing device (16) for mixing the first pulse signal (w1) and the carrier frequency signal (T), and the radar pulse signal (R1) emitted from the single-sideband mixing device (16) is essentially located in a sideband of the carrier frequency signal (T).

The present invention relates to a radar measuring device, which is capable of being used for a motor vehicle in particular, and a method for operating a radar measuring device.

Radar measuring devices are used in motor vehicles in particular for measuring the distance from and speed relative to other objects. Detection can take place in any angular range around the vehicle, whereby the measured signals are used in particular for accident prevention (precrash), collosion avoidance, stop-and-go ACC (adaptive cruise control), parking assistance, jam assistance, blind spot monitoring, and for lane departure warning and lane changing assistance. Detection takes place in front of the vehicle at short range, up to 10 m (short range radar, SRR), e.g., in frequency ranges up to 40 GHz, at mid-range, up to 40 m, and at long range, up to 120 m, at higher frequencies of 77 GHz, for example.

With pulse-echo radar measurements, distances can be determined by measuring propagation time and relative speeds based on time differentiation of the distance value and/or Doppler measurement. To this end, a carrier frequency signal is connected through by a switch triggered with a pulse signal, whereby, depending on the modulation, pulses of the carrier frequency signal are produced which are 200 ps to 1000 ps long, for example. The modulation by the switch corresponds to multiplication of the carrier frequency signal by the (square wave) pulse signal. A transmission spectrum results which has a center carrier frequency and a power which drops off both ways from the carrier frequency. At a carrier frequency of 24 GHz, for example, a spectrum of approximately 22-26 GHz results with a pulse length of 350 ps and a pulse repetition rate in the megahertz range.

The bandwidths required for pulse radar systems are problematic in particular with frequencies of 10 to 40 GHz, which are relevant for short range, however. Due to restricted bands, in particular the bands for safety-relevant aeronautical radio services and navigation radio services, and radio astronomy, only narrow bandwidths-some having a bandwidth less than 1 GHz—are permitted in the frequency range between 10 and 40 GHz.

In contrast, the radar measuring device as recited in claim 1 and the method for operating a radar measuring device as recited in claim 12 have the advantage, in particular, that a narrow bandwidth is occupied and a high resistance to interference is achieved. Furthermore, a system having a narrow band and high power can be used in an ISM band with relatively little equipment outlay, and without duplication of essential components of the device in particular. Advantageously, the carrier frequency signal which is not relevant for the evaluation of the signals is largely suppressed in single-sideband modulation. A high processing gain is possible when the bandwidth is increased to 24 to 31.2 GHz, for example. According to the invention, microwave systems can be used, in particular in the frequency range of 21.6 to 23.6 GHz. Since only one sideband is transmitted, ultra wide band (UWB) systems can be used.

The present invention is based on the finding that conventional pulse modulation, with which the carrier frequency signal is connected through using a switch triggered by the pulse signal, basically corresponds to double sideband modulation, as is used in amplitude modulation in the radio frequency range, for example. Double sideband modulation of this nature is basically not necessary in pulse radar systems or pulse-echo radar systems, however, and, due to the necessary bandwidth and the strong carrier frequency signal which does not deliver any additional information in the signal evaluation, only results in disadvantageous effects. In contrast, the means of attaining the goal of the invention, per the present invention, makes it possible to occupy a narrow bandwidth with high suppression of the carrier frequency in a surprisingly simple manner by using a single sideband mixing device instead of the switch which brings about multiplication.

Short range detection (SRD) pulses can be used for modulation, for example. Furthermore, PN (pseudo noise) modulation with a PN code can also be used; in this case, a decision is made based on the PN code as to whether a pulse is transmitted or not, and the reflected pulse signals which are received can be processed via correlation for detection of the target object based on the known coding.

According to the present invention, an upper sideband can be transmitted in particular, with suppressed carrier frequency. Via constant-voltage free coupling-in of the pulse signal, the spectral density can be displaced to higher frequencies, so that the carrier frequency can be suppressed even better.

With regard for receiving the reflected radar signals and processing the radar signals, according to the present invention, the received radar signal can be mixed in a manner known per se with a carrier frequency signal which is pulse-modulated in a time-delayed manner in an IQ mixer to determine the in-phase signal and quadrature signal. Furthermore, a single-sideband mixing device can be used, instead of the switching device, on the receiving end as well. The correlation can take place in the baseband (e.g., 0 to 2 GHz or 0 to 4 GHz).

The present invention will be described below with reference to the attached drawing of a few exemplary embodiments.

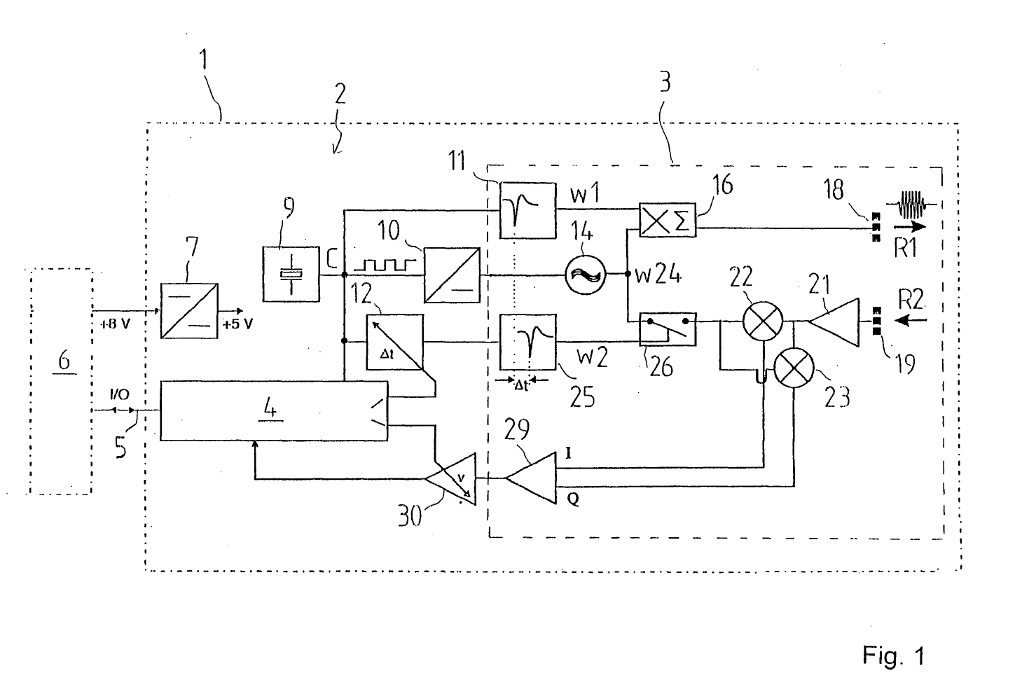

FIG. 1 shows a block diagram of a radar measuring device according to a first embodiment of the present invention with a single-sideband mixing device on the sending end;

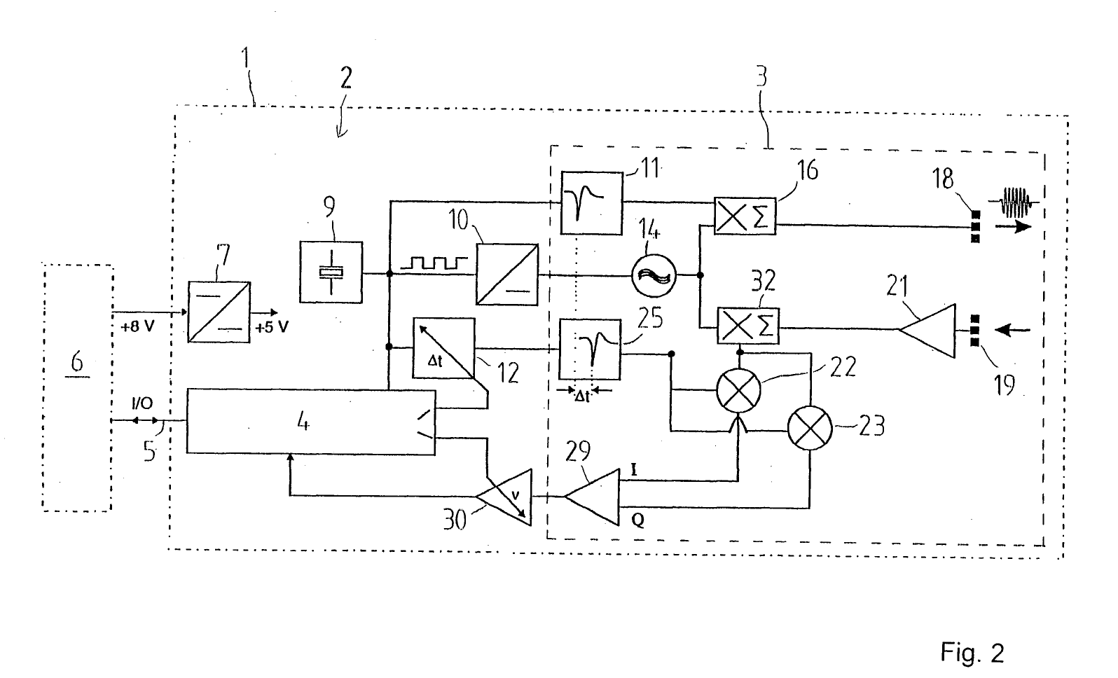

FIG. 2 shows a block diagram of a radar measuring device according to a further embodiment of the present invention with single-sideband mixing devices on the sending end and the receiving end.

A radar measuring device 1 includes a low-frequency stage 2 and a high-frequency stage 3. A control device 4 for low-frequency stage 2, e.g., a microcontroller or a digital signal processor (DSP), is connected via a bus 5 with an external control device 6 of a motor vehicle. A DC-to-DC converter 7 converts a direct voltage of 8 V to a direct voltage of 5 V, which is suitable for a radar measuring device. A timing generator 9 emits a clock signal with a clock frequency of 5 MHz to control device 7, among other things, and to a voltage transformer 10, a first pulse-shaping device 11 and a time-delay device 12, the time delay Δt of which is adjustable using an analog output of control device 7.

The output signal of voltage transformer 10 is input as bias voltage in a high-frequency oscillator 14 with a frequency of 24 GHz. Pulse signal w1 output by first pulse-shaping device 11 and a high-frequency carrier signal w24 from high-frequency oscillator 14 are mixed in a single-sideband mixer 16, producing a modulated radar pulse signal R1. Basically, a mixing device known from amplitude modulation can be used as single-sideband mixer 16. In this case, carrier frequency signal w24 and pulse signal w1 are each shifted by 90° and the resultant product term is added to the unshifted value, resulting in:
2a·cos(t·w1)·cos(t·w24)−2a·sin(t·w1)·sin(t·w24)

Applying trigonometric transformation results in:
[a·cos(t·w24+t·w1)+a·cos(t·w24−t·w1)]
−[a·cos(t·w24−t·w1)−a·cos(t·w24+t·w1)]
and, finally:
   2·a·cos(t·w24+t·w1)

Using multiplication, summation and subtraction, two sidebands are therefore produced, and the lower one is canceled out by interference. The carrier frequency is also suppressed. Radar pulse signal R1 formed by the pulse-shaping device in this manner is output and emitted by mixer 16 to transmission antenna 18.

A radar signal R2 reflected by an object is received by a receiving antenna 19 and forwarded to an IQ mixer 22, 23 by an amplifier 21. Transmission and receiving antennas 18, 19 can be designed to be separate or as combination transmission and receiving antennas. The clock signal is time-delayed by the value Δt via time-delay device 12 and forwarded to a second pulse-shaping device 25 which produces the same impulses as the first pulse-shaping device 12, with the predetermined time delay Δt. The time-delayed pulse signal formed in this manner is supplied to a switching device 26 for pulse modulation, which connects carrier frequency signal w24 from high-frequency oscillator 14 through as a function of time-delayed pulse signal w2 and also forwards delayed, pulsed radar signals formed in this manner to IQ mixer 22, 23.

The IQ mixer includes two multiplication devices 22, 23, to which the two radar signals are supplied directly or with a phase shift of π/2 (90°). From this, an in-phase signal I and a quadrature signal Q are formed, based on which a signal processor 29 determines a geometric sum. The output signal from processor 29 is forwarded via an amplifier 30 with amplification v, which is controllable by control device 4, which, in turn, determines a distance based on the time lag between received radar signal R2 and sent radar pulse signal R1.

With the embodiment shown in FIG. 2, a single-sideband mixer 32 is also used on the receiving end, instead of switching device 19. Single-sideband mixer 32 mixes the amplfied, received radar signal output by amplification device 21 with the carrier frequency signal from high-frequency oscillator 14 and outputs a signal to IQ mixer 22, 23, which also accepts time-delayed pulse signal w2 from second pulse-shaping device 25.

1. A radar measuring device, in particular for a motor vehicle, with a high-frequency oscillator (14) for producing a carrier frequency signal (w24), transmission means (11, 16, 18) for producing and transmitting a radar pulse signal (R1), whereby the transmission means include a first pulse-shaping device (11) for producing a first pulse signal (w1) and a transmission antenna (18) for emitting a radar pulse signal (R1) composed of the first pulse signal (w1) and the carrier frequency signal (w24), reception means (19, 21) for receiving a radar signal (R2), and processing means (12, 21, 22, 23, 25, 26, 29, 30) for processing the received radar signal (R2), whereby the processing means include a second pulse-shaping device (25) for producing a second pulse signal (w2),
whereby the transmission means include a single-sideband mixing device (16) for mixing the first pulse signal (w1) and the carrier frequency signal (T), and the radar pulse signal (R1) emitted from the single-sideband mixing device (16) is essentially located in a sideband of the carrier frequency signal (T).

2. The radar measuring device as recited in claim 1,
wherein the radar pulse signal (R1) emitted from the single-sideband mixing device (16) is an upper sideband signal with a suppressed carrier frequency, the signal frequencies of which are essentially located above the carrier frequency of the carrier frequency signal (w24).

3. The radar measuring device as recited in claim 1, wherein the first pulse signal (w1) is input to the single-sideband mixing device (16) at least substantially free of constant voltage.

4. The radar measuring device as recited in claim 1, wherein the carrier frequency of the carrier frequency signal (w24) is in the range of 10 to 40 GHz, preferably 22 to 26 GHz, e.g., at 24 GHz, and the first and second pulse signal (w1, w2) include pulses which are 200 ps to 1000 ps long, and preferably approximately 350 ps long.

5. The radar measuring device as recited in claim 1, wherein the processing means (12, 21, 22, 23, 25, 26, 29, 30) include a switching device (26) which connects the carrier frequency signal (w24) through as a function of the second pulse signal (w2) and outputs a second radar pulse signal, and the second radar pulse signal and the received radar signal (R2) are output to an IQ mixing device (22, 23) for determining an in-phase signal (I) and a quadrature signal (Q)

6. The radar measuring device as recited in claim 1, wherein the processing means include a second single-sideband mixing device (32) for mixing the carrier signal frequency (w24) and the received radar signal (R2) and outputting a second sideband signal.

7. The radar measuring device as recited in claim 6, wherein the second single-sideband mixing device (29) outputs the second sideband signal to an IQ mixing device (22, 23) for determining an in-phase signal (I) and a quadrature signal (Q).

8. The radar measuring device as recited in claim 6, wherein the correlation takes place in the baseband, preferably at 0 GHz to 2 GHz or 0 GHz to 4 GHz.

9. The radar measuring device as recited in claim 1, wherein a time-delay device (12) is provided for receiving a clock signal (C) and outputting a clock signal delayed by a variable time difference ( [symbol] t) to the second pulse-shaping device (25), and the second pulse signal (w2) emitted from the second pulse-shaping device (25) has the same pulse length and pulse repetition frequency as the first pulse signal (w1).

10. The radar measuring device as recited in claim 9,
wherein it includes a control device (4), preferably a microcontroller (4) or a digital signal processor, for controlling the time-delay device (12).

11. The radar measuring device as recited in claim 9, wherein the control device (4) determines a signal propagation time based on the phase difference of the received radar signal (R2) compared to the transmitted, pulsed radar signal (R1).

12. A method for operating a radar measuring device, comprising the steps:
Generate a carrier frequency signal,
Shape the initial pulse signals,
Generate radar pulse signals from the pulse signal and the carrier frequency signal,
Transmit the radar pulse signals (R1),
Receive radar pulse signals (R2),
Process the received radar pulse signals and determine an in-phase signal (I) and a quadrature signal (Q),
whereby the radar pulse signals are produced via single-sideband mixing of the first pulse signal and the carrier frequency signal.

13. The method as recited in claim 12,
wherein, in the single-sideband mixing, an upper sideband with suppressed carrier frequency is generated.

14. The method as recited in claim 12,
wherein a single-sideband signal—preferably an upper sideband located above the carrier frequency—is generated from the received radar signals (R2) and the carrier frequency signal (w24) via single-sideband mixing, and an in-phase signal and a quadrature signal are determined from the single-sideband signal and a second radar pulse signal via IQ mixing.
